(19) United States
(12) Patent Application Publication
(10) Pub. No.: US 2002/0014037 A1
(43) Pub. Date: Feb. 7, 2002

(54) Aceric anchor

(76) Inventor: Martin Dumas, Honfleur (CA)

Correspondence Address: Martin Dumas, c/o: Paul Biron, Box 0732, Jackman, ME, 04945-0732, US

(21) Appl. No.: 09/895,615

(22) Filed: Jul. 2, 2001

(30) Foreign Application Priority Data
Jun. 27, 2000 (CA) 2,311,751

(51) Int. Cl. A01G 23/10

(52) U.S. Cl. 47/11

(57) ABSTRACT

The present invention relates to a sap collecting device, in which an aceric gathering anchor is placed in a tree trunk hole, it draws sap and a plug closes the hole after the season is over. A ball valve type of anchor comprises a channel for sap compatible to existing tubing. A conical shallow tap hole is first drilled. At the head of the anchor there is a plug which is embedded in the sap wood and the anchor is maintained by the bark permanently. A permanent sealing cap surrounds the head of the plug and is maintained moist, to prevent dryness and to limit other hazards, as well as to augment circulation of the sap, thereby providing a sustainable alternative to maple bush, permitting fewer tappings and less damages.

### FIELD OF INTEREST OF THE INVENTION

The present invention relates to a sap collecting device, in which an aceric gathering anchor placed in a tree trunk hole, draws sap and a plug closes the hole after the season is over.

### DESCRIPTION OF THE PRIOR ART

Considering the importance to maintain a sustainable aceric ecosystem and the economic impact of maple sugar production, the search of viable alternatives, led to a reflection on permanence of tap holes, to eliminate excessive punching of trees and labor needs. In a review of prior art one finds certain patent documents sharing common objectives with the above. These patents are as follows: U.S. Pat. No. 2,825,182 Ayres in 1958 utilizes in a vacuum system, a ball 12 as means of closing an aperture 11 in a conical spout during the harvesting season, but the ball remains inside the conical spout. The purpose of the ball is to prevent the entering of air and the return of water into the tap when the vacuum action slows down.

CA 2,129,005 in 2000 Merving treats trees through tap holes by incorporating a chemical substance in a plug. This plug enters flush with the bark and possesses two protruding legs which spread to let the chemical flow.

CA 1,285,390 in 1991 Merving proposes a method to heal trees by utilizing a wooden plug made of two parts. A head part in the tree is large enough to retain chemicals for slow release, while a rear part is retained by the bark.

CA 2,305,862 filed on Apr. 24^{th} 2000 by the present inventor describes an anchor ring which attaches to the bark.

### OBJECTIVES

A general object of the invention is to hasten the healing of the scarred maple trees, after the removal of the spouts, by limiting the harmful effects on the taps such as: splitting, rotting, action of pests and diseases, drying of the trees and, on the contrary, accelerating the recovery process. A first objective is to supply a valve type of anchor which comprises a channel for sap compatible to existing tubing. A second objective is to supply a plug which penetrates the sap wood and is maintained by the bark permanently, completely hermetic, while keeping the tap hole humid. A third objective is to supply a slanting plug which comprises a point carrying a wet compress, thus permitting the circulation of sap around the point.

### DESCRIPTION OF THE DRAWINGS

The present invention will further understood from the following description with reference to the drawings in which:

FIG. 1 is a perspective of an aceric anchor plug.

FIG. 2 is a face view of the anchor plug of FIG. 1.

FIG. 3 is a cut view according to line 3-3 of FIG. 2

FIG. 4 is a perspective of a cover part of FIG. 1.

### DESCRIPTION OF A PREFERRED EMBODIMENT

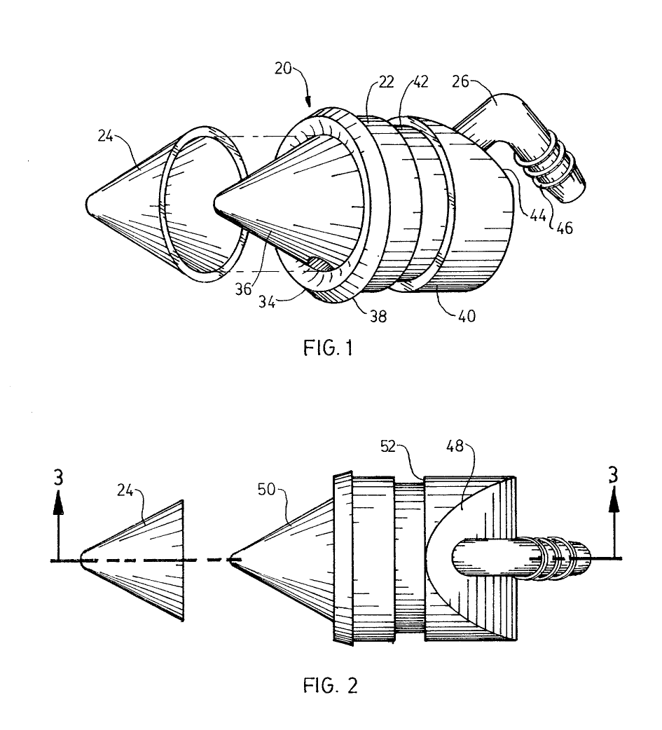

A preferred embodiment of the invention is illustrated in FIG. 1 where the same characterizing elements are identified by the same numbers.

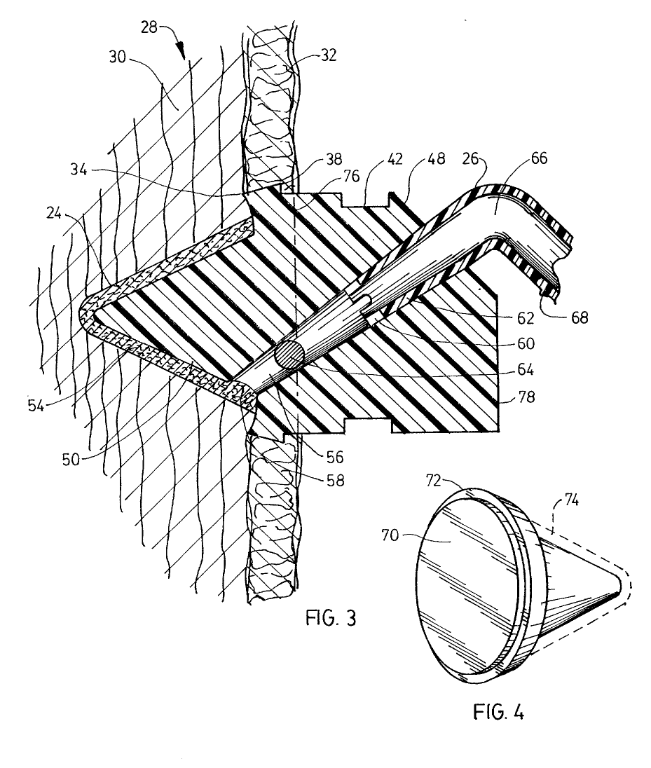

FIG. 1 illustrates an aceric anchor 20 for installation into a maple tree tap hole. The aceric anchor comprises three parts of which an anchor collector 22, a mobile tubular adapter 26 and a permanent sealing cap 24. The cap 24 is conical, made of absorbent fibers, such as felt 54, permitting continuous circulation of the sap. The anchor 22 possesses a retaining sealing cone 36 with a biting contour 34 to insure a proper sealed hold in the sapwood. The anchor 22 possesses a backwater lip 38 to lock into a tree bark (see FIG. 3) and an exterior wall 40 opposite the biting contour 34. Towards the center of external wall 40 appears a grip ring 42 and at the external and towards the higher level one sees a sloped bottom 44 on which the tubular adapter 26 stays put. This adapter possesses backwater grip rings 46 for tubes. The retaining cone 36 is adapted to receive cap 24 against a slanting face 48 and it shows at its base a sap entry opening.

FIG. 2 illustrates in face view the aceric anchor 20. One remarks the slanting face 48 which receives the adapter 26, to permit easy flow of sap into a pail or a tube. A point 50 is mounted forwardly to facilitate partial penetration into a tree; one sees a tool groove 52 for an extraction tool.

FIG. 3 illustrates a cut view of the aceric anchor 20 installed within a maple tree 28, especially in the sapwood region 30, by means of the biting contour 34 and well anchored in the bark 32 by means of the backwater lip 38. One sees on a triangular point 50 a felt 54. The adaptater 26 penetrates into an oblique cavity 56 wherein is found a sap entry 58 at the lower end of the point 50. Towards the middle of the oblique cavity 56 one sees hydrodynamic apertures 60 at a conical forward end 62 of adapter 26. In the oblique cavity 56 one sees a ball valve 64. The ball valve has a certain weight to determine its position thus permitting the opening and the shutting to control its action. An elbow channel 66 comprises a tubular backwater ring 68 at a back end and joins the hydrodynamic openings 60 at the forward end 62. One sees a dotted line which corresponds to the limit of the bark and to the limit of a permanent plug 76. One sees also a hammer face 78 to suggest hitting against the back to embed the anchor 22. The ball 64 is located near the sap entry 58 and under the effect of succion may roll up and down along the oblique cavity 56. FIG. 4 illustrates in perspective a permanent plug 70. The plug 70 possesses a backwater plug lip 72 and a permanent sealing cap 74 which permits the continuous circulation of the sap around the plug. The plug and its felt cap permit the travel of the sap up and down through the sapwood while maintaining the entrance sealed during summer, fall and winter, namely during the off season.

Biological Effects

On an innocuity and salubrity level, I observed that the sources of potential infections from bacteria and other pathogens are concentrated in the very end of the spout and inside the tree. To prevent the infections, it seems that the tree creates a callus by the combined effect of air, new cells, and substances secreted conducting to the healing of the scars. With my new aceric anchor the gripping within the tree goes deeper in the tree than the level of the bark, as well as the biting contour 34 enters a little of the sap wood where pathogens are expected. The anchor contour is sealed and most pathogens stopped in their proliferation inside the spout, for the lack of air. The spout and its parts may be made out of different materials, as well as the anchor 22, the adapter 26 and the cap 24 and may serve to collect the sap of many different tree species, spread in several countries.

The tap hole may be made with a special drill bit, directly in the sapwood. The tap hole is shallow and correspond to the anchor point 50 plus the space required for the felt cap 54.

The tap hole being shallow and having a large diameter, one may obtain an abundant and sweeter sap, avoiding great damages by limiting de depth. Incidentally, the tree heals faster considering the fact that trees grow about ¼″ on diameter, the tap hole may be done in the year growth becoming a sustainable alternative.

Search Parameters

This sap collecting disposal permits several improvements:

Prevent the tree splits;

Keep the cut wet;

The drain is made by disconnecting the adapter 26.

The tap hole may have a variable slant angle according to the depth of the point 50 and the cap contour 24; the tap hole may be profound, such as ½″ and have a larger diameter such as 1¼″ for increasing the sap flow. The tree reacts greatly to heal its small tap holes. Trials conducted in the spring of 2000 on this spout allow to believe that this alternative improves the flow and could possibly be used two years in a row. With my anchor the cleaning is done simply by removing the adaptor and placing it back into the conical tube. This sway the preparation work is done for the subsequent year.

It is understood that the mode of embodiment of the present invention which has been described herewith in reference to the annexed drawing, has been given as an indication and is non limitative and that modifications and adaptations may be brought about without departing from the object of the present invention. Other embodiments are possible and limited only by the scope of the following claims:

Parts List

20 aceric anchor

22 anchor collector

24 cap

26 mobile tubulure adapter

28 maple

30 sap wood

32 bark

34 biting contour

36 retaining cone

38 back water lip

40 exterior wall

42 grip ring

44 slope bottomfond en pente

46 back water of the tube

48 slanting face

50 point

52 tool groove

54 felt

56 slanting cavity

58 sap aperture

60 hydrodynamic aperture

62 conical forward end

64 ball valve

66 elbow channel

68 tubular backwater

70 permanent cap

72 backwater cover

73 point cover

74 permanent sealing cap

76 cover limit

78 hammering surface

I claim:

1. In a sap producing tree having a bark layer (32) and a sapwood (30), a sap collecting method comprising the following steps:
a) drill through said bark and said sapwood a channel creating a tap hole to collect said sap,
b) dispose in said channel a sealing cap (24) in porous material to permit flowing of said sap,
c) install a collector anchor (22) comprising a main corps and a point (50) mounted at the fore end thereof, said point being of smaller size than said channel, thereby leaving free space for said cap, said main corps comprising a slanting cavity (56) having a conical shape, from a position of a sap aperture (58) and to a position corresponding to an exit channel for said sap,
d) orient said anchor (22) so said slanting cavity be oriented from bottom to top, said aperture (58) being at said bottom, said main corps being gripped in said sapwood (30) and said bark layer (32) by hammering the back of said anchor (78);
e) introduce in said conical shape a ball valve (64) of diameter larger than said aperture (58) and introduce in said exit a conical forward end (62) of an elbow channel (66) comprising retaining means for retaining said ball within said slanting cavity,
f) apply a vacuum, said sap impregnating said sealing and circulating inside said cavity, said ball valve being aspirated by said vacuum and raising in said conical and wider part of said cavity, said sap passing around said ball and proceeding to an exiting channel for collection;
g) after season install in said channel a permanent plug (70) and fasten it to said sapwood.

2. The method of claim 1 comprising a supplementary step wherein said channel is conical, said point (50) is also conical and said cap (24) has a shape corresponding to that of said channel.

3. In a tree having a thickness of bark (32) and a sapwood (30) having a sap releasing hole, a sap collecting device defining an aceric anchor comprising:
a collecting anchor (22) comprising means to tie into said hole and means to tie into said bark around said hole, said anchor (22) comprising an external wall (40), a convex entrance face adapted to communicate with said sapwood and an exit face (48),
a cap comprising a convex part adapted to surround said hole and a concave part adapted to spouse said entrance face, said cap when maintained in a position hidden from external air maintaining humidity, thereby permitting sap to surround it in order to circulate in said sapwood.

4. The anchor (22) of claim 3 comprising means for channeling sap from said entrance face up to said exit face.

5. The anchor of claim 3 wherein said anchoring means at the level of said sapwood comprise a biting contour (34) located on said exterior wall (40) at the level of said entrance face and disposed on the circumference of said exterior wall, said contour comprising a backwater part (38) exceeding said exterior face and adapted to limit a recoil of said anchor once inserted in said bark.

6. The anchor of claim 5 comprising a grip ring (42) disposed around said exterior wall (40) and comprising a tool groove (52) destined to permit extraction of said anchor.

7. The anchor of claim 4 wherein said channeling means comprise a slanting cavity (56) having a conical shape starting from said sap aperture (58) up to a sap exit channel (66), said anchor (22) being possibly oriented so that said slanting cavity (56) be upwardly slanted from bottom to top, said aperture (58) being at said bottom, said conical form permitting receiving a ball valve (64) of a diameter slightly larger than that of said aperture (58) and said exit receiving a conical forward end (62) of an elbow channel (66), said conical end comprising means to retain said ball within said oblique cavity.

8. The anchor of claim 4 comprising a sloped bottom (44) comprising a slanting face (48) permitting to receive perpendicularly an elbow channel (66) comprising a tubular backwater (68) to combine with a vacuum channel.

9. In a tree having a bark layer (32) and a sapwood (30) having a taphole defining a channel releasing sap, a sealing cap (74) comprising:
a convex part adapted to suit said taphole and having a concave interior part,
a permanent cap (70) comprising anchor means to said sapwood and to said bark around said tap hole, said cap (70) comprising a cover limit (76), a point cover (73) of dimension smaller than said channel, thereby leaving free space for said cap,
said cap being maintained in position hidden from exterior air, thereby being kept wet and permitting said sap to surround it and circulate in said sapwood.
